(19) United States
(12) Patent Application Publication
(10) Pub. No.: US 2026/0351119 A1
(43) Pub. Date: Nov. 5, 2026

(54) ERROR CORRECTION AND NORMALIZATION OF TELEMATICS DATA FOR MACHINE LEARNING

(71) Applicant: Nirvana Tech, Inc., San Francisco, CA (US)

(72) Inventors: Abhay Mitra, Hillsborough, CA (US); Anand Kumar Singh, Lucknow (IN); Sanket Rathi, Calgary (CA); Sarthak Agrawal, Bengaluru (IN)

(21) Appl. No.: 19/251,016

(22) Filed: Jun. 26, 2025

(30) Foreign Application Priority Data
May 3, 2025 (IN) 202521042988

(51) Int. Cl. G08G 1/00; H04L 1/00; H04W 4/021

(52) U.S. Cl. CPC G08G 1/207; H04L 1/0061; H04W 4/021

(57) ABSTRACT

A method includes transmitting authorization from a first system to a second system to transmit first telematics data from at least one fleet of vehicles, receiving, at the first system, the first telematics data from the at least one fleet of vehicles in response to the authorization, normalizing the received first telematics data to generate first normalized telematics data, error correcting the first normalized telematics data to generate first error corrected normalized telematics data, and applying machine learning to the first error corrected normalized telematics data to determine at least one of garaging location of the at least one fleet, radius of operation of the at least one fleet, and hazard zones of the at least one fleet.

### PRIORITY

This patent application claims the benefit of priority to India Application Serial No. 202521042988, filed May 3, 2025, which is incorporated by reference herein in its entirety.

### TECHNICAL FIELD

This disclosure is directed to advanced data processing architectures that enable secure, scalable, and efficient handling of diverse telematics data sources while maintaining data privacy

### BACKGROUND

Telematics systems have become increasingly important in managing fleets of vehicles, providing valuable data on vehicle location, performance, and driver behavior. However, the telematics landscape is complex, with multiple telematics service providers (TSPs) offering different data types, formats, and quality levels.

Fleet operators often work with multiple TSPs, each using proprietary devices and data formats. This creates challenges in data integration, normalization, and analysis across the entire fleet. Additionally, the quality and reliability of telematics data can vary significantly between providers and even between individual devices.

Current systems struggle to effectively normalize and error-correct telematics data from diverse sources. This makes it difficult for fleet operators to gain accurate, comprehensive insights into their operations, such as determining precise garaging locations, operational radii, and potential hazard zones as well as determining a driver behavior score, a route risk score, etc.

There is a need for an advanced system that can ingest telematics data from multiple sources, normalize it into a common format, perform sophisticated error correction, and apply machine learning techniques to extract valuable insights. Such a system would enable fleet operators to make more informed decisions, improve safety, and optimize their operations across diverse vehicle types and geographical areas. Further, external safety consultants, companies looking to provide services based on a fleet's telematics data (e.g., fuel cards, financing, brokerages etc.) might benefit.

### SUMMARY

In one aspect, a method includes transmitting authorization from a first system to a second system to transmit first telematics data from at least one fleet of vehicles, receiving, at the first system, the first telematics data from the at least one fleet of vehicles in response to the authorization, normalizing the received first telematics data to generate first normalized telematics data, error correcting the first normalized telematics data to generate first error corrected normalized telematics data, and applying machine learning to the first error corrected normalized telematics data to determine a physical property of the at least one fleet (e.g., at least one of garaging location of the at least one fleet, radius of operation of the at least one fleet, and hazard zones of the at least one fleet).

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 illustrates an overview of a system for collecting and processing telematics data from multiple fleets and telematics service providers (TSPs) in accordance with one example.

FIG. 2 depicts the components of the system for processing telematics data in accordance with one example.

FIG. 3 illustrates a flowchart depicting a method for processing telematics data.

FIG. 4 illustrates a machine-learning pipeline, according to some examples.

FIG. 5 illustrates training and use of a machine-learning program, according to some examples.

FIG. 6 is a diagrammatic representation of a machine in the form of a computer system within which a set of instructions may be executed to cause the machine to perform any one or more of the methodologies discussed herein, according to some examples.

### DETAILED DESCRIPTION

This disclosure provides a novel system and method for processing and analyzing telematics data from multiple sources to derive valuable insights for fleet management. This disclosure addresses the challenges associated with collecting, normalizing, and analyzing diverse telematics data from various telematics service providers (TSPs) and fleet vehicles.

The disclosure's unique approach to handling diverse telematics data sources and its sophisticated processing pipeline represents a significant advancement in the field of fleet management and telematics data processing.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

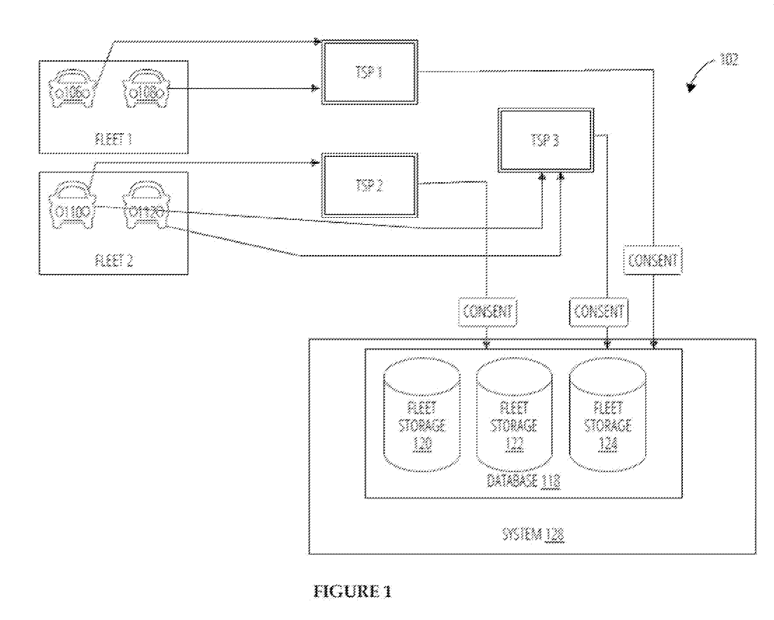

FIG. 1 illustrates an overview of a system for collecting and processing telematics data from multiple fleets and telematics service providers (TSPs) in accordance with one example.

The system is designed to address the complexities of handling diverse data sources and formats in the field of fleet management. Components of the system include:

Telematics Service Providers (TSPs): The figure depicts multiple TSPs (TSP 1, TSP 2, TSP 3) connected to different fleets of vehicles. While three TSPs are listed, there may be additional TSPs in practice, with multiple TSPs servicing a single fleet. For example, Fleet 2 may transmit telematics data to both TSP2 and TSP3. In an example, TSP2 may collect braking data and speed data while TSP3 collects GPS data. Each TSP represents a distinct data source, potentially with its own proprietary data format, transmission protocol, and consent mechanism.

Fleet Vehicles: Multiple fleets (Fleet 1, Fleet 2) are shown, each potentially connected to one or more TSPs. While each fleet shows two vehicles (106, 108, 110 and 112), fewer or additional vehicles may be included in each fleet. There may be fewer or additional fleets. The fleet may contain multiple types of vehicles, such as trucks, cars, drones, etc. In an example, Fleet 1 may transmit all telematics data to TSP1 while Fleet 2 may transmit data to both TSP2 and TSP3. The Fleet 2 may use two TSPs because the vehicles 110 and 112 use different telematics providers for the same data type or different data type. For example, Vehicle 110 may send camera data to TSP 2 and GPS data to TSP3. Vehicle 112 may send both camera data and GPS data to TSP3 as the telematics installed in vehicle 112 comes from the same vendor while vehicle 110 uses different telematics vendors. Alternatively, vehicle 110 may have additional telematics sensors installed compared to vehicle 112.

Fleet Storage: The system incorporates separate fleet storage components (120, 122, 124) in a database 118 for each fleet. This segregated storage architecture serves multiple purposes:
It ensures data privacy and security by keeping each fleet's data separate.
It allows for fleet-specific data retention policies and access controls.
It facilitates scalability, as new fleets can be added to the system without impacting existing data structures.

Note that in order to pull telematics data from the TSPs to the database 118, the system 128 transmits authorization (consent) to the TSPs, which verifies the authorization. If authorized, then the TSPs will transmit the telematics data to the database 118. Different TSPs may have varying consent mechanisms, The system 128 ensures compliance with data privacy regulations and maintains a record of authorizations for audit purposes.

The system (128), responsible for processing the telematics data from all sources. This system performs several functions:
Data Normalization: It transforms the diverse incoming data into a standardized format, addressing variations in data types, sampling rates, and provider-specific schemas.
Error Correction: It applies sophisticated algorithms to improve data quality, handling issues such as anomalous readings, device-specific biases, and sampling rate discrepancies.
Machine Learning Analysis: It employs advanced machine learning techniques to extract valuable insights from the processed data, such as determining garaging locations, operational radii, and potential hazard zones.

The architecture depicted in FIG. 1 is designed to handle the complexities of modern telematics data processing:
It accommodates multiple data sources with different formats, protocols, and quality levels.
It ensures proper data privacy and consent management across diverse TSPs and fleet operators.
It provides a scalable solution that can grow with the addition of new fleets and data sources.
It centralizes the critical functions of data normalization, error correction, and analysis, enabling consistent processing across all data sources.

This comprehensive approach allows fleet operators to gain more accurate and holistic insights into their operations, overcoming the challenges of data integration from multiple TSPs and enabling more informed decision-making in fleet management.

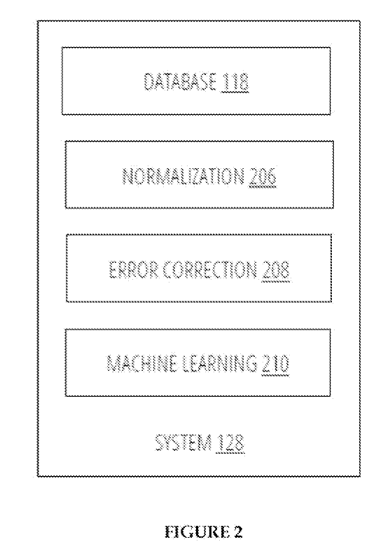

FIG. 2 depicts the components of the system 128 for processing telematics data.

The system includes three components that work together to process and analyze the collected telematics data:
1. Normalization Component 206:
Transforms diverse incoming data into a standardized format
Handles different data types, sampling rates, and provider-specific schemas
Maintains a catalog of transformation functions for each provider and data type
Processes data streams by vehicle and time intervals
Collects metadata about transformation operations
2. Error Correction Component 208:
Processes the normalized data to improve quality and reliability
Implements multiple error correction strategies including:
   Dropping erroneous data points while maintaining minimum sampling rates
   Extrapolating data points when needed
   Cross-referencing different data types (e.g., braking data with GPS)
   Applying statistical models to correct device-specific biases
   Builds and maintains characteristic maps from historical data
   Tracks metadata about error patterns and corrections
   Error correction may include predictive error modeling, anomaly detection based on ML algorithms, real-time feedback mechanisms, etc.
3. Machine Learning Component 210:
Analyzes the error-corrected normalized data
Processes both current and historical data
Enables continuous learning and adaptation based on accumulated data patterns
Generates insights including:
   i. Garaging Location Analysis:
   Determination of primary and secondary garaging locations for fleet vehicles
   Identification of patterns in vehicle storage and operational bases
   ii. Operational Radius Assessment:
   Calculation of how far vehicles operate from their center of operations
   Analysis of operational coverage (e.g., 50% of operational time within certain radius)
   Assessment of maintenance implications based on operational radius (e.g., service accessibility)
   iii. Risk Assessment:
   Generation of risk scores based on multiple data points
   Identification of location hazard zones
   Analysis of operational patterns that may impact risk levels
   Driver behavior scores
   Route risk scores
   iv. Usage-Based Analytics:
   Tracking of vehicle mileage for usage-based billing
   Monthly distance traveled calculations
   Generation of automated invoicing based on actual usage
   v. Vehicle and Driver Behavior Analysis:
   Monitoring of vehicle-driver mappings over time
   Analysis of driving patterns and behaviors
   Integration of GPS data with other telemetry data for comprehensive behavior assessment
   vi. Maintenance and Service Insights:
   Analysis of service accessibility based on operational patterns
   Assessment of maintenance needs based on vehicle usage and location patterns
   Identification of potential maintenance risks based on operational radius

The components work in sequence, with data flowing from normalization through error correction and finally to machine learning analysis, creating a pipeline for processing telematics data from multiple sources.

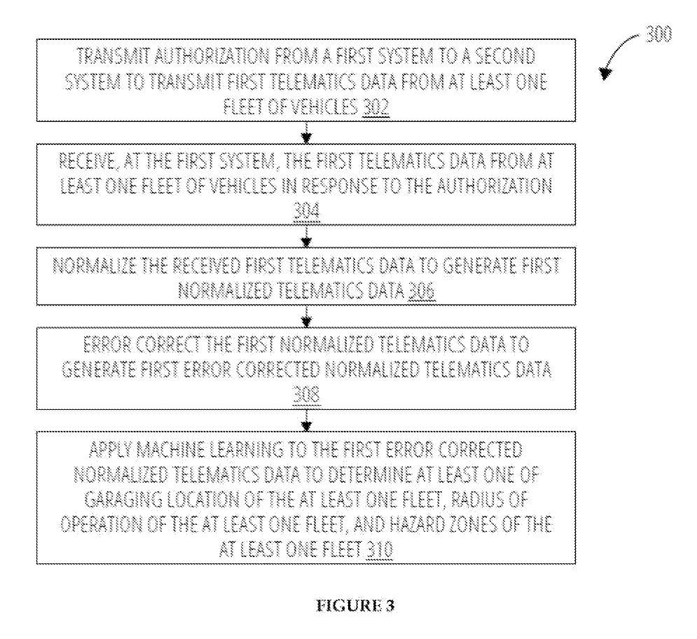

FIG. 3 illustrates a routine 300 depicting a method for processing telematics data, with the following:
1. Transmit Authorization (302):
The first system transmits authorization to a second system to transmit first telematics data from at least one fleet of vehicles
In an alternative embodiment, authorization may also be transmitted to a third system to transmit second telematics data of a same and/or different type
2. Receive Telematics Data (304):
The first system receives the first telematics data from the fleet vehicles in response to the authorization
Optionally, the system may receive second telematics data from the third system
3. Normalize Data (306):
The received telematics data is normalized to generate normalized telematics data
For multiple data types, both first and second telematics data are normalized separately
4. Error Correct Data (308):
The normalized data undergoes error correction to generate error-corrected normalized telematics data
Alternative error correction methods include:
   Dropping erroneous data points if sampling rate remains above threshold
   Extrapolating data points to maintain sampling rate
   Verifying braking data by cross-referencing with GPS data
   Using statistical models to correct device bias
   Correcting data based on statistical models when values exceed thresholds
   Comparing data against characteristic maps from historical data
5. Apply Machine Learning (310):
Machine learning is applied to the error-corrected normalized telematics data
The analysis determines:
   Garaging location of the fleet
   Radius of operation of the fleet
   Hazard zones of the fleet
In one example, the system may generate a geofence based on the determined locations to prevent crossing by the fleet. The geofence prevents fleet members from physically entering a fenced zone (e.g., by deactivating fleet members upon entering a zone, transmitting routing information to avoid fenced zones, transmitting alerts when a fleet member is about to enter a zone).

In an example, the routine 300 may include causing telematics in one or more vehicles in one or more fleets to collect and transmit data to the system 128 directly and/or via a TSP.

In an example, the routine 300 can enrich the telematics data with additional (e.g., dependent) data from other sources like maps, weather, traffic, etc.

Accordingly, the routine 300 maintains data integrity via normalization and error correction so that the database 118 hold accurate and correct data and the machine learning 210 can be perform accurate determinations based on valid data.

In an example, the routine 300 may further assign a first access level to a first device to read the determined physical property of a first fleet of the at least one fleet; receive an access request for the determined physical property of the first fleet from the first device; and transmit the determined physical property of the at least one fleet to the first device. The first access level may be assigned to a customer or agency of the first fleet. The first access level can be limited by a predetermined time (e.g., length of an insurance contract) and require renewal when/if the insurance contract renews with the same agency.

The routine 300 may further assign a second access level to a second device to read the determined physical property of a second fleet of the at least one fleet, wherein the second access level is different from the first access level (e.g., different fleet data, different granularity of data, etc.); receive an access request for the determined physical property of the second fleet from the second device; and transmit the determined physical property of the at least one fleet to the first device.

The first and/or second access levels may require access via a predetermined application.

The routine 300 represents a process that can be implemented as a method, stored on a non-transitory computer-readable storage medium, or executed by a system comprising at least one processor and memory components.

### MACHINE-LEARNING PIPELINE 500

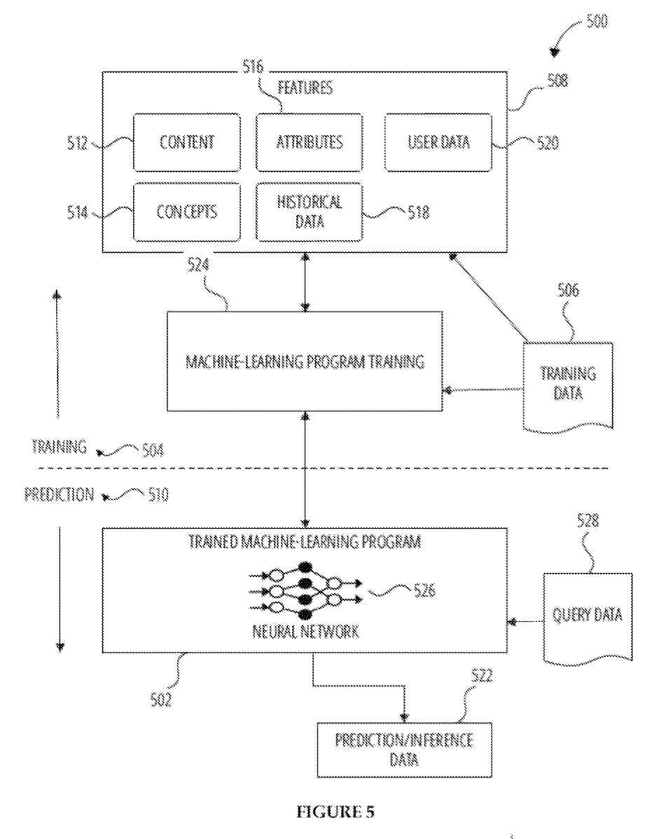

FIG. 5 is a flowchart depicting a machine-learning pipeline 500, according to some examples. The machine-learning pipeline 500 may be used to generate a trained model, for example the trained machine-learning program 502 of FIG. 5, to perform operations associated with searches and query responses.

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Training phases 504

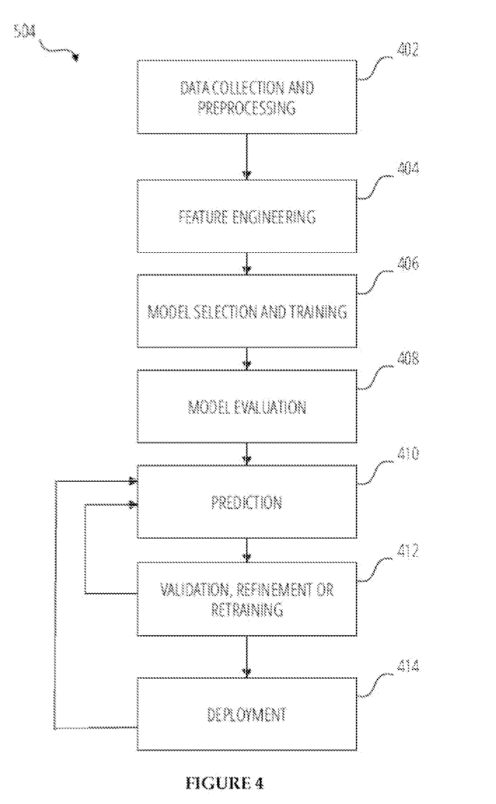

Generating a trained machine-learning program 502 may include multiple phases that form part of the machine-learning pipeline 500, including for example the following phases illustrated in FIG. 4:
Data collection and preprocessing 402: This phase may include acquiring and cleaning data to ensure that it is suitable for use in the machine learning model. This phase may also include removing duplicates, handling missing values, and converting data into a suitable format.
Feature engineering 404: This phase may include selecting and transforming the training data 506 to create features that are useful for predicting the target variable. Feature engineering may include (1) receiving features 508 (e.g., as structured or labeled data in supervised learning) and/or (2) identifying features 508 (e.g., unstructured or unlabeled data for unsupervised learning) in training data 506.
Model selection and training 406: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 408: This phase may include evaluating the performance of a trained model (e.g., the trained machine-learning program 502) on a separate testing dataset. This phase can help determine if the model is overfitting or underfitting and determine whether the model is suitable for deployment.
Prediction 410: This phase involves using a trained model (e.g., trained machine-learning program 502) to generate predictions on new, unseen data.
Validation, refinement or retraining 412: This phase may include updating a model based on feedback generated from the prediction phase, such as new data or user feedback.
Deployment 414: This phase may include integrating the trained model (e.g., the trained machine-learning program 502) into a more extensive system or application, such as a web service, mobile app, or IoT device. This phase can involve setting up APIs, building a user interface, and ensuring that the model is scalable and can handle large volumes of data.

FIG. 5 illustrates further details of two example phases, namely a training phase 504 (e.g., part of the model selection and trainings 406) and a prediction phase 510 (part of prediction 410). Prior to the training phase 504, feature engineering 404 is used to identify features 508. This may include identifying informative, discriminating, and independent features for effectively operating the trained machine-learning program 502 in pattern recognition, classification, and regression. In some examples, the training data 506 includes labeled data, known for pre-identified features 508 and one or more outcomes. Each of the features 508 may be a variable or attribute, such as an individual measurable property of a process, article, system, or phenomenon represented by a data set (e.g., the training data 506). Features 508 may also be of different types, such as numeric features, strings, and graphs, and may include one or more of content 512, concepts 514, attributes 516, historical data 518 , and/or user data 520, merely for example.

In training phase 504, the machine-learning pipeline 500 uses the training data 506 to find correlations among the features 508 that affect a predicted outcome or prediction/inference data 522.

With the training data 506 and the identified features 508, the trained machine-learning program 502 is trained during the training phase 504 during machine-learning program training 524. The machine-learning program training 524 appraises values of the features 508 as they correlate to the training data 506. The result of the training is the trained machine-learning program 502 (e.g., a trained or learned model).

Further, the training phase 504 may involve machine learning, in which the training data 506 is structured (e.g., labeled during preprocessing operations). The trained machine-learning program 502 implements a neural network 526 capable of performing, for example, classification and clustering operations. In other examples, the training phase 504 may involve deep learning, in which the training data 506 is unstructured, and the trained machine-learning program 502 implements a deep neural network 526 that can perform both feature extraction and classification/clustering operations.

In some examples, a neural network 526 may be generated during the training phase 504, and implemented within the trained machine-learning program 502. The neural network 526 includes a hierarchical (e.g., layered) organization of neurons, with each layer comprising multiple neurons or nodes. Neurons in the input layer receive the input data, while neurons in the output layer produce the final output of the network. Between the input and output layers, there may be one or more hidden layers, each comprising multiple neurons.

Each neuron in the neural network 526 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 526 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 504, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 510, the trained machine-learning program 502 uses the features 508 for analyzing query data 528 to generate inferences, outcomes, or predictions, as examples of a prediction/inference data 522. For example, during prediction phase 510, the trained machine-learning program 502 generates an output. Query data 528 is provided as an input to the trained machine-learning program 502, and the trained machine-learning program 502 generates the prediction/inference data 522 as output, responsive to receipt of the query data 528.

In some examples, the trained machine-learning program 502 may be a generative AI model. Generative AI is a term that may refer to any type of artificial intelligence that can create new content from training data 506. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the output prediction/inference data 522 include predictions, translations, summaries or media content.

### MACHINE ARCHITECTURE

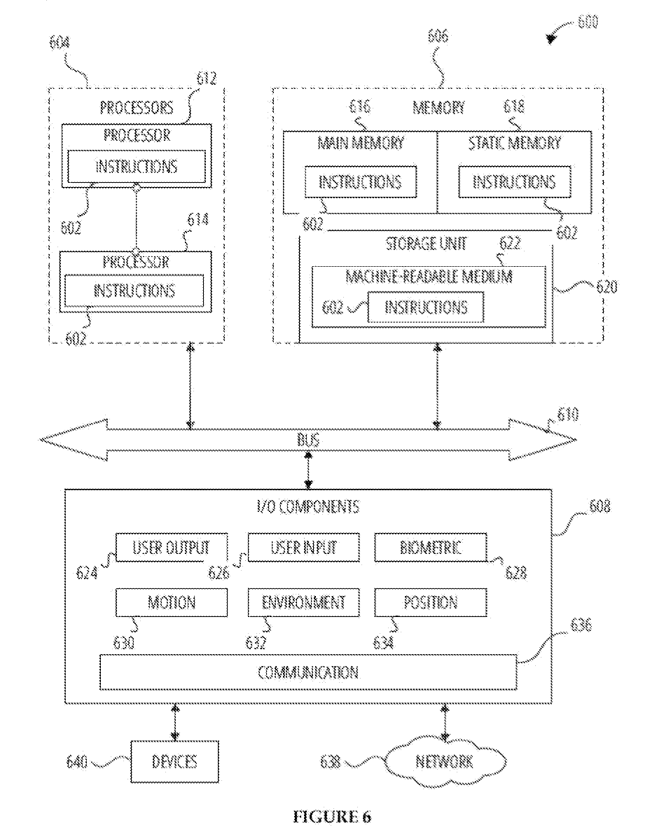

FIG. 6 is a diagrammatic representation of the machine 600 within which instructions 602 (e.g., software, a program, an application, an applet, an app, or other executable code) for causing the machine 600 to perform any one or more of the methodologies discussed herein may be executed. For example, the instructions 602 may cause the machine 600 to execute any one or more of the methods described herein. The instructions 602 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 602, sequentially or otherwise, that specify actions to be taken by the machine 600. Further, while a single machine 600 is illustrated, the term "machine" shall also be taken to include a collection of machines that individually or jointly execute the instructions 602 to perform any one or more of the methodologies discussed herein. The machine 600, for example, may be installed on any of the vehicles or comprise system 128 or any one of multiple server devices forming part of system 128. In some examples, the machine 600 may also comprise both client and server systems, with certain operations of a particular method or algorithm being performed on the server-side and with certain operations of the method or algorithm being performed on the client-side.

The machine 600 may include Processors 604, memory 606, and input/output I/O components 608, which may be configured to communicate with each other via a bus 610.

The memory 606 includes a main memory 616, a static memory 618, and a storage unit 620, both accessible to the Processors 604 via the bus 610. The main memory 606, the static memory 618, and storage unit 620 store the instructions 602 embodying any one or more of the methodologies or functions described herein. The instructions 602 may also reside, completely or partially, within the main memory 616, within the static memory 618, within machine-readable medium 622 within the storage unit 620, within at least one of the Processors 604 (e.g., within the processor's cache memory), or any suitable combination thereof, during execution thereof by the machine 600.

The I/O components 608 may include a wide variety of components to receive input, provide output, produce output, transmit information, exchange information, capture measurements, and so on. The specific I/O components 608 that are included in a particular machine will depend on the type of machine. For example, portable machines such as mobile phones may include a touch input device or other such input mechanisms, while a headless server machine will likely not include such a touch input device. It will be appreciated that the I/O components 608 may include many other components that are not shown in FIG. 6. In various examples, the I/O components 608 may include user output components 624 and user input components 626. The user output components 624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 630 include acceleration sensor components (e.g., accelerometer), gravitation sensor components, rotation sensor components (e.g., gyroscope).

The environmental components 632 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the machine 600 may have a camera system comprising, for example, front cameras on a front surface of the machine 600 and rear cameras on a rear surface of the machine 600. In addition to front and rear cameras, the machine 600 may also include a 360° camera for capturing 360° photographs and videos.

Moreover, the camera system of the machine 600 may be equipped with advanced multi-camera configurations. This may include dual rear cameras, which might comprise a primary camera for general photography and a depth-sensing camera for capturing detailed depth information in a scene. In addition to dual camera setups, the machine 600 may also feature triple, quad, or even penta camera configurations on both the front and rear sides of the machine 600. These multiple cameras systems may include a wide camera, an ultra-wide camera, a telephoto camera, a macro camera, and a depth sensor, for example.

Communication may be implemented using a wide variety of technologies. The I/O components 608 further include communication components 636 operable to couple the machine 600 to a Network 638 or devices 640 via respective coupling or connections. For example, the communication components 636 may include a network interface component or another suitable device to interface with the Network 638. In further examples, the communication components 636 may include wired communication components, wireless communication components, cellular communication components, Near Field Communication (NFC) components, Bluetooth^{®} components (e.g., Bluetooth^{®} Low Energy), Wi-Fi^{®} components, and other communication components to provide communication via other modalities. The devices 640 may be another machine or any of a wide variety of peripheral devices (e.g., a peripheral device coupled via a USB).

Moreover, the communication components 636 may detect identifiers or include components operable to detect identifiers. For example, the communication components 636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph^{TM}, MaxiCode, PDF417, Ultra Code, UCC RSS-2D bar code, and other optical codes), or acoustic detection components (e.g., microphones to identify tagged audio signals). In addition, a variety of information may be derived via the communication components 636, such as location via Internet Protocol (IP) geolocation, location via Wi-Fi® signal triangulation, location via detecting an NFC beacon signal that may indicate a particular location, and so forth.

The various memories (e.g., main memory 616, static memory 618, and memory of the Processors 604) and storage unit 620 may store one or more sets of instructions and data structures (e.g., software) embodying or used by any one or more of the methodologies or functions described herein. These instructions (e.g., the instructions 602), when executed by Processors 604, cause various operations to implement the disclosed examples.

The instructions 602 may be transmitted or received over the Network 638, using a transmission medium, via a network interface device (e.g., a network interface component included in the communication components 636) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 640.

### EXAMPLE STATEMENTS

Example 1 is a method including
transmitting authorization from a first system to a second system to transmit first telematics data from at least one fleet of vehicles;
receiving, at the first system, the first telematics data from the at least one fleet of vehicles in response to the authorization;
normalizing the received first telematics data to generate first normalized telematics data;
error correcting the first normalized telematics data to generate first error corrected normalized telematics data; and
applying machine learning to the first error corrected normalized telematics data to determine at a physical property of the at least one fleet.

In Example 2, the subject matter of Example 1 further comprising
transmitting authorization from the first system to a third system to transmit second telematics data from the at least one fleet of vehicles, wherein the first telematics data is of a different type than the second telematics data;
receiving, at the first system, the second telematics data from at least one fleet of vehicles in response to the authorization received at the third system;
normalizing the received second telematics data to generate second normalized telematics data;
error correcting the second normalized telematics data to generate second error corrected normalized telematics data; and
adding the second error corrected normalized telematics data to the first error corrected normalized telematics data before the applying.

In Example 3, the subject matter of Examples 1–2 wherein the physical property includes at least one of garaging location of the at least one fleet, radius of operation of the at least one fleet, and hazard zones of the at least one fleet and wherein the method further comprises generating a geofence based on at least one of the determined garaging location of the at least one fleet, the radius of operation of the at least one fleet, and the hazard zones of the at least one fleet to prevent crossing of the geofence by the at least one fleet.

In Example 4, the subject matter of Examples 1–3 wherein the error correcting includes dropping an erroneous data point if the dropping will not lower a sampling rate below a predetermined threshold.

In Example 5, the subject matter of Examples 1–4 wherein the error correcting includes extrapolating a data point to maintain a predetermined sampling rate.

In Example 6, the subject matter of Examples 1–5 wherein the error correcting includes verifying braking data points by cross referencing the braking data points with global positioning system data.

In Example 7, the subject matter of Examples 1–6 further comprising generating a statistical model of telematics data and wherein the error correcting corrects for device bias using the statistical model.

In Example 8, the subject matter of Examples 1–7 further comprising generating a statistical model of telematics data for a telematics device and wherein the error correcting corrects the first normalized telematics data for predefined period of time based on the statistical model when values for the first normalized telematics data exceed a predefined threshold.

In Example 9, the subject matter of Examples 1–8 further comprising generating a data characteristic map from historical data and comparing the first telematics data with the data characteristic map and wherein the error correcting includes adjusting the first telematics data when the first telematics data varies from the data characteristic map by more than a predetermined threshold.

In Example 10, the subject matter of Examples 1–9 wherein the error correcting includes at least one of predictive error modeling, anomaly detection based on machine learning algorithms and real-time feedback mechanisms.

In Example 11, the subject matter of Examples 1-10 further comprising adding data from a fourth system to the telematics data before the normalizing, wherein the added data includes at least one of maps, weather and traffic.

In Example 12, the subject matter of Examples 1-11 further comprising:
assigning a first access level to a first device to read the determined physical property of a first fleet of the at least one fleet;
receiving an access request for the determined physical property of the first fleet from the first device; and
transmitting the determined physical property of the at least one fleet to the first device.

In Example 13, the subject matter of Examples 1-12 further comprising:
assigning a second access level to a second device to read the determined physical property of a second fleet of the at least one fleet, wherein the second access level is different from the first access level;
receiving an access request for the determined physical property of the second fleet from the second device; and
transmitting the determined physical property of the at least one fleet to the first device.

In Example 14, the subject matter of Examples 1-13, wherein the first access level expires after a predetermined amount of time.

Example 15 is a non-transitory computer readable having stored thereon instructions to cause at least one processor to execute any of examples 1 – 14.

Example 16 is a system to implement of any of Examples 1–14.

### TERM EXAMPLES

"Client device" may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

"Component" may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A "hardware component" is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase "hardware component"(or "hardware-implemented component") should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, "processor-implemented component" may refer to a hardware component implemented using one or more processors. Similarly, the methods described herein may be at least partially Processor-implemented, with a particular processor or processors being an example of hardware. For example, at least some of the operations of a method may be performed by one or more processors or processor-implemented components. Moreover, the one or more processors may also operate to support performance of the relevant operations in a "cloud computing" environment or as a "software as a service" (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

"Computer-readable storage medium" may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

"Machine storage medium" may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms "machine-storage medium," "device-storage medium," "computer-storage medium" mean the same thing and may be used interchangeably in this disclosure. The terms "machine-storage media," "computer-storage media," and "device-storage media" specifically exclude carrier waves, modulated data signals, and other such media, at least some of which are covered under the term "signal medium."

"Network" may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

"Non-transitory computer-readable storage medium" may include, for example, a tangible medium that is capable of storing, encoding, or carrying the instructions for execution by a machine.

"Processor" may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term "processor" may include multi-core processors that may comprise two or more independent processors (sometimes referred to as "cores") that may execute instructions contemporaneously. These cores can be homogeneous (e.g., all cores are identical, as in multicore CPUs) or heterogeneous (e.g., cores are not identical, as in many modern GPUs and some CPUs). In addition, the term "processor" may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

"Signal medium" may include, for example, an intangible medium that is capable of storing, encoding, or carrying the instructions for execution by a machine and includes digital or analog communications signals or other intangible media to facilitate communication of software or data. The term "signal medium" shall be taken to include any form of a modulated data signal, carrier wave, and so forth. The term "modulated data signal" means a signal that has one or more of its characteristics set or changed in such a matter as to encode information in the signal. The terms "transmission medium" and "signal medium" mean the same thing and may be used interchangeably in this disclosure.

The disclosure provides a solution for processing and analyzing telematics data from multiple sources, addressing challenges in collecting and error correcting telematics data to enable accurate processing of the telematics data with machine learning.

The system's architecture enables secure data collection from various TSPs while managing different consent mechanisms and data formats.

Through its sophisticated normalization and error correction processes, the system transforms diverse telematics data into actionable insights. The normalization component handles various data types and sampling rates, while the error correction component employs multiple strategies to improve data quality, including statistical modeling and cross-referencing of different data types.

The machine learning component builds upon this processed data to generate valuable insights about fleet operations, including garaging locations, operational radii, and hazard zones. These insights enable fleet operators to make more informed decisions about their operations, improve safety measures, and optimize fleet management.

The invention's modular architecture, comprising separate fleet storage components and a centralized consent database, ensures scalability and data privacy compliance. This design allows the system to grow with the addition of new fleets and adapt to evolving telematics data sources.

What is claimed is:

1. A method comprising:
transmitting authorization from a first system to a second system to transmit first telematics data from at least one fleet of vehicles;
receiving, at the first system, the first telematics data from the at least one fleet of vehicles in response to the authorization;
normalizing the received first telematics data to generate first normalized telematics data;
error correcting the first normalized telematics data to generate first error corrected normalized telematics data; and
applying machine learning to the first error corrected normalized telematics data to determine a physical property of the at least one fleet.

2. The method of claim 1, further comprising:
transmitting authorization from the first system to a third system to transmit second telematics data from the at least one fleet of vehicles, wherein the first telematics data is of a different type than the second telematics data;
receiving, at the first system, the second telematics data from at least one fleet of vehicles in response to the authorization received at the third system;
normalizing the received second telematics data to generate second normalized telematics data;
error correcting the second normalized telematics data to generate second error corrected normalized telematics data; and
adding the second error corrected normalized telematics data to the first error corrected normalized telematics data before the applying.

3. The method of claim 1, wherein the physical property includes at least one of garaging location of the at least one fleet, radius of operation of the at least one fleet, and hazard zones of the at least one fleet and wherein the method further comprises generating a geofence based on at least one of the garaging location of the at least one fleet, the radius of operation of the at least one fleet, and the hazard zones of the at least one fleet to prevent crossing of the geofence by the at least one fleet.

4. The method of claim 1, wherein the error correcting includes dropping an erroneous data point if the dropping will not lower a sampling rate below a predetermined threshold.

5. The method of claim 1, wherein the error correcting includes extrapolating a data point to maintain a predetermined sampling rate.

6. The method of claim 1, wherein the error correcting includes verifying braking data points by cross referencing the braking data points with global positioning system data.

7. The method of claim 1, further comprising generating a statistical model of telematics data and wherein the error correcting corrects for device bias using the statistical model.

8. The method of claim 1, further comprising generating a statistical model of telematics data for a telematics device and wherein the error correcting corrects the first normalized telematics data for predefined period of time based on the statistical model when values for the first normalized telematics data exceed a predefined threshold.

9. The method of claim 1, further comprising generating a data characteristic map from historical data and comparing the first telematics data with the data characteristic map and wherein the error correcting includes adjusting the first telematics data when the first telematics data varies from the data characteristic map by more than a predetermined threshold.

10. A non-transitory computer-readable storage medium storing instructions that, when executed by at least one processor, cause the at least one processor to perform operations comprising:
transmitting authorization from a first system to a second system to transmit first telematics data from at least one fleet of vehicles;
receiving, at the first system, the first telematics data from at least one fleet of vehicles in response to the authorization;
normalizing the received first telematics data to generate first normalized telematics data;
error correcting the first normalized telematics data to generate first error corrected normalized telematics data; and
applying machine learning to the first error corrected normalized telematics data to determine a physical property of the at least one fleet.

11. A telematics system comprising:
at least one processor;
at least one memory component storing instructions that, when executed by the at least one processor, cause the at least one processor to perform operations comprising:
transmitting authorization from a first system to a second system to transmit first telematics data from at least one fleet of vehicles;
receiving, at the first system, the first telematics data from at least one fleet of vehicles in response to the authorization;
normalizing the received first telematics data to generate first normalized telematics data;
error correcting the first normalized telematics data to generate first error corrected normalized telematics data; and
applying machine learning to the first error corrected normalized telematics data to determine a physical property of the at least one fleet.

12. The telematics system of claim 11, wherein the instructions further cause the at least one processor to perform operations comprising:
transmit authorization from the first system to a third system to transmit second telematics data from the at least one fleet of vehicles, wherein the first telematics data is of a different type than the second telematics data;
receive, at the first system, the second telematics data from at least one fleet of vehicles in response to the authorization received at the third system;
normalize the received second telematics data to generate second normalized telematics data;
error correct the second normalized telematics data to generate second error corrected normalized telematics data; and
add the second error corrected normalized telematics data to the first error corrected normalized telematics data before the applying.

13. The telematics system of claim 11, wherein the physical property includes at least one of garaging location of the at least one fleet, radius of operation of the at least one fleet, and hazard zones of the at least one fleet and wherein the operations further comprise generating a geofence based on at least one of the garaging location of the at least one fleet, the radius of operation of the at least one fleet, and the hazard zones of the at least one fleet to prevent crossing of the geofence by the at least one fleet.

14. The telematics system of claim 11, wherein the error correcting includes dropping an erroneous data point if the dropping will not lower a sampling rate below a predetermined threshold.

15. The telematics system of claim 11, wherein the error correcting includes extrapolating a data point to maintain a predetermined sampling rate.

16. The telematics system of claim 11, wherein the error correcting includes verifying braking data points by cross referencing the braking data points with global positioning system data.

17. The telematics system of claim 11, wherein the instructions further cause the at least one processor to perform operations comprising generating a statistical model of telematics data and wherein the error correcting corrects for device bias using the statistical model.

18. The telematics system of claim 11, wherein the instructions further cause the at least one processor to perform operations comprising: generating a statistical model of telematics data for a telematics device and wherein the error correcting corrects the first normalized telematics data for predefined period of time based on the statistical model when values for the first normalized telematics data exceed a predefined threshold.

19. The telematics system of claim 11, wherein the instructions further cause the at least one processor to perform operations comprising generating a data characteristic map from historical data and comparing the first telematics data with the data characteristic map and wherein the error correcting includes adjusting the first telematics data when the first telematics data varies from the data characteristic map by more than a predetermined threshold.

20. The telematics system of claim 11, wherein the error correcting includes at least one of predictive error modeling, anomaly detection based on machine learning algorithms and real-time feedback mechanisms.

21. The telematics system of claim 11, wherein the instructions further cause the at least one processor to perform operations comprising adding data from a fourth system to the telematics data before the normalizing, wherein the added data includes at least one of maps, weather and traffic.

22. The telematics system of claim 11, wherein the instructions further cause the at least one processor to perform operations comprising:
assigning a first access level to a first device to read the determined physical property of a first fleet of the at least one fleet;
receiving an access request for the determined physical property of the first fleet from the first device; and
transmitting the determined physical property of the at least one fleet to the first device.

23. The telematics system of claim 22, wherein the instructions further cause the at least one processor to perform operations comprising:
assigning a second access level to a second device to read the determined physical property of a second fleet of the at least one fleet, wherein the second access level is different from the first access level;
receiving an access request for the determined physical property of the second fleet from the second device; and
transmitting the determined physical property of the at least one fleet to the first device.

24. The telematics system of claim 22, wherein the first access level expires after a predetermined amount of time.
